(19) United States
(12) Patent Application Publication
(10) Pub. No.: US 2003/0192028 A1
(43) Pub. Date: Oct. 9, 2003

(54) System and method for determining software object migration sequences

(75) Inventors: Carl Phillip Gusler, Austin, TX (US); Rick Allen Hamilton II, Charlottesville, VA (US); James O'Higgins, Toronto (CA); Ronald Andrew Verbeek, Ancaster (CA)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/116,564

(22) Filed: Apr. 4, 2002

(51) Int. Cl. G06F 9/44

(52) U.S. Cl. 717/101

(57) ABSTRACT

A system and method for determining software object migration sequences is presented. Objects for hardware platform migration are identified and assigned an object identifier. Decision factors and corresponding weightings are assigned which are used in determining an object migration order. Object identifier grades are determined for each decision factor corresponding to each object identifier. The object identifier grades are multiplied with corresponding decision factor weightings which results in decision factor scores. The decision factor scores for each object identifier are added together which results in a migration score for the corresponding object identifier. The migration scores along with object dependencies are used to generate a migration order. The migration order is import to a project planning software which generates a migration project plan.

### BACKGROUND OF THE INVENTION

1. Technical Field

The present invention relates in general to a system and method for determining software object migration sequences. More particularly, the present invention relates to a system and method for selecting decision factors and calculating a migration score for use in constructing a migration sequence.

2. Description of the Related Art

In today's complex information systems (IS) environments, IS departments are challenged with generating appropriate methodologies for numerous actions. One of the more complicated processes that an IS department faces is the planning of large-scale migrations of applications between hardware platforms. One reason an IS department migrates applications between hardware platforms is to achieve performance increases. For example, the IS department may decide that upgrading an existing server system to a different vendor's server system significantly increases data transfer rates which will increase customer satisfaction.

Another reason IS departments migrate hardware platforms is for cost cutting measures. For example, large-scale computer systems are sometimes constructed in stages. Each stage may have a separate server system in order for the stage to quickly achieve operational status. When the large-scale computer system is fully implemented, the computer system may include many server systems which are not fully utilized. The IS department may choose to migrate objects from a first server system to a second server system in order to re-sell the first server system.

A challenge found with migrating software objects, such as applications, databases, and data structures, is scheduling a migration sequence based upon dependencies between the objects. For example, a database installation and configuration should be migrated prior to an application that sets atop the database. This may be obvious when migrating a few applications, but the migration sequence becomes more challenging when migrating hundreds of applications and databases.

Furthermore, each application may have a different number of users at different status levels within the organization. For example, a first application may have hundreds of users while a second application may have less than ten users. The ten users, however, may be the top management in the organization. A challenge found with scheduling software migration sequences is objectively weighing who the users are with other factors, such as the importance of what the users are performing with the application.

What is needed, therefore, is a way to schedule largescale migrations using an objective, systematic approach.

### SUMMARY

It has been discovered that decision factors and object grading may be used to generate an objective migration schedule. A customer determines which objects to migrate and if the objects have associated dependencies. The customer then assigns decision factor criteria and weighting which is used in conjunction with an object identifier grade to generate a migration score. The migration score is analyzed in combination with object dependencies to generate a migration plan.

The customer requires object migrations from one hardware platform to another hardware platform which may be based upon cost cutting measures or system performance enhancements. As those skilled in the art can appreciate, objects may include applications, databases, data structures, and files. The customer selects the objects for migration and assigns an object identifier (i.e. the object name). The customer also determines object dependencies upon another object. For example, an application that sets atop a database may be dependent upon the database being migrated prior to the application.

The customer assigns decision factors and corresponding weightings for use in determining an object migration sequence. A decision factor weighting is a positive or negative number used to show how important each particular decision factor is compared to the other decision factors in determining the migration order of an object.

The customer reviews each decision factor corresponding to each object identifier and assigns a corresponding object identifier grade. In one embodiment, a high grade indicates that the decision factor is high for the particular object. For example, an object that generates billing statements would have a high grade for an “Importance” decision factor.

Each object identifier grade is multiplied with the corresponding decision factor weighting which results in a decision factor score. After each decision factor score is calculated corresponding to each decision factor and object identifier grade, the decision factor scores corresponding to an object identifier are added together which results in a migration score for the object identifier.

A migration order is generated based upon migration scores. Object dependencies are analyzed and, if appropriate, the migration order is adjusted accordingly. For example, an application that sets atop a database is dependent upon the database to migrate prior to the application. The database is moved ahead of the application in the migration order regardless of its corresponding migration score relative to the applications corresponding migration score.

The migration order is imported into a project planner to generate a migration schedule. Information Systems (IS) staff input may also be input into the project planner, such as resource availability, to create a realistic migration schedule. The migration schedule is sent to the IS department for implementation.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing customer inputs used to compute migration scores and generate a migration schedule;

FIG. 2A is a spreadsheet example showing object identifier grades for various decision factors;

FIG. 2B is a spreadsheet showing object identifiers sorted based upon migration scores and corresponding dependencies;

FIG. 3 is a high-level flowchart showing steps taken in generating a software migration plan;

FIG. 4 is a flowchart assigning weightings to corresponding decision factors;

FIG. 5 is a flowchart showing a customer assigning object identifier grades to corresponding decision factors;

FIG. 6 is a flowchart showing steps taken in computing migration scores for use in generating a migration order;

FIG. 7 is a flowchart showing steps taken in generating a migration order based upon migration scores and object identifier dependencies; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

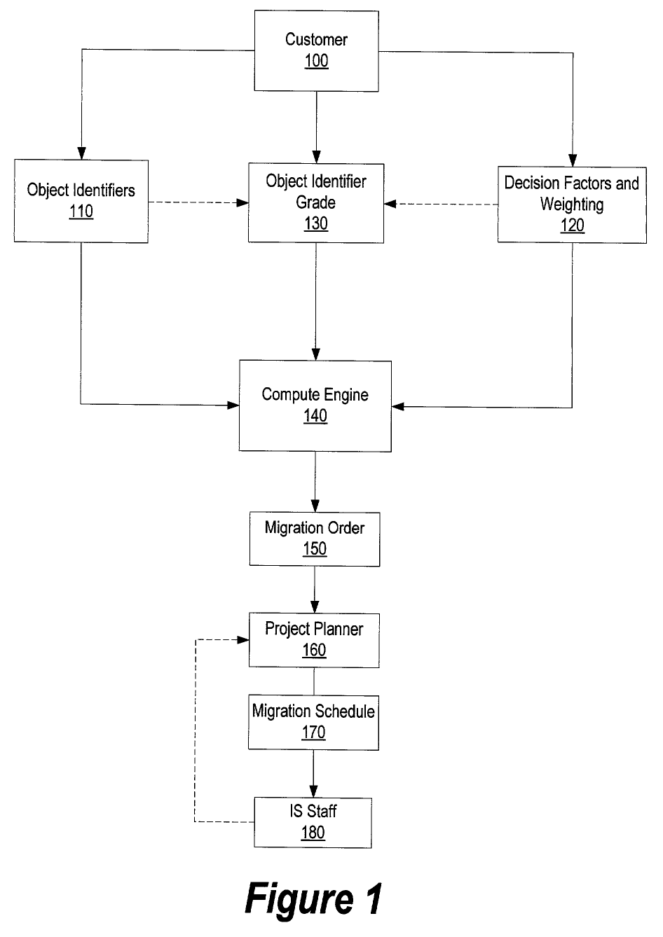

FIG. 1 is a diagram showing customer inputs used to compute migration scores and generate a migration schedule. Customer 100 requires object migrations from one platform to another platform. The migration may be based upon cost cutting measures or system performance enhancements. The objects may include applications, databases, data structures, and files. Customer 100 selects the objects for migration and assigns an object identifier (i.e. the object name) to each object. Customer 100 also determines if an object has dependencies upon another object. For example, an application that sets atop a database may be dependent upon the database being migrated prior to the application. Object identifiers 110 includes a list of object identifiers and corresponding dependencies.

Customer 100 assigns decision factors and corresponding weightings (decision factors and weightings 120) for use in determining an object migration sequence. A decision factor weighting is a positive or negative number used to quantify the importance of a particular decision factor compared to the other decision factors in determining the migration order of an object.

A positive decision factor weighting indicates that the decision factor contributes to early migration while a negative decision factor indicates that the decision factor contributes to late migration. A small number indicates that the decision factor is less important, and may serve as a “tie breaker” for two applications with very similar assessments. A large number indicates that the decision factor is more important and is critical in determining how early objects will migrate.

Customer 100 reviews each decision factor corresponding to each object identifier and assigns a corresponding grade. In one embodiment, a high grade indicates that the decision factor is high for the particular object. For example, an object that generates billing statements would have a high object identifier grade for an “Importance” decision factor. Object identifier grading 130 includes object identifier grades corresponding to each decision factor reviewed with each object identifier.

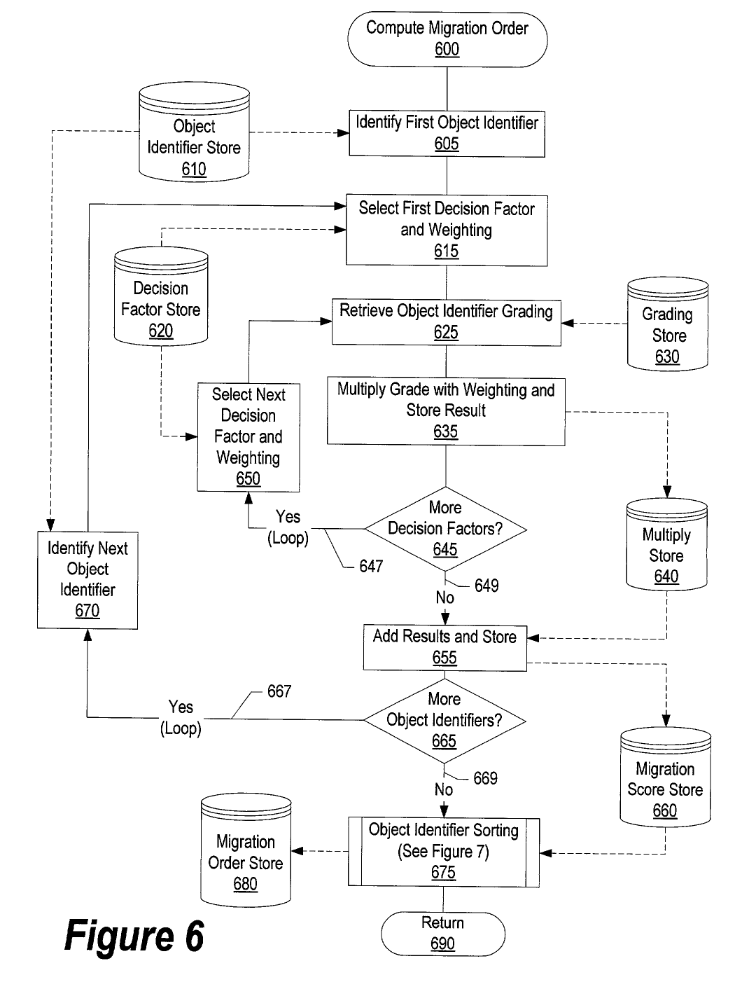

Object identifiers 110, object identifier grading 130, and decision factor and weighting 120 are input to compute engine 140. Compute engine 140 determines a migration score for each object identifier based upon decision factor weightings and object identifier grades (see FIG. 6 for further details regarding migration score calculations).

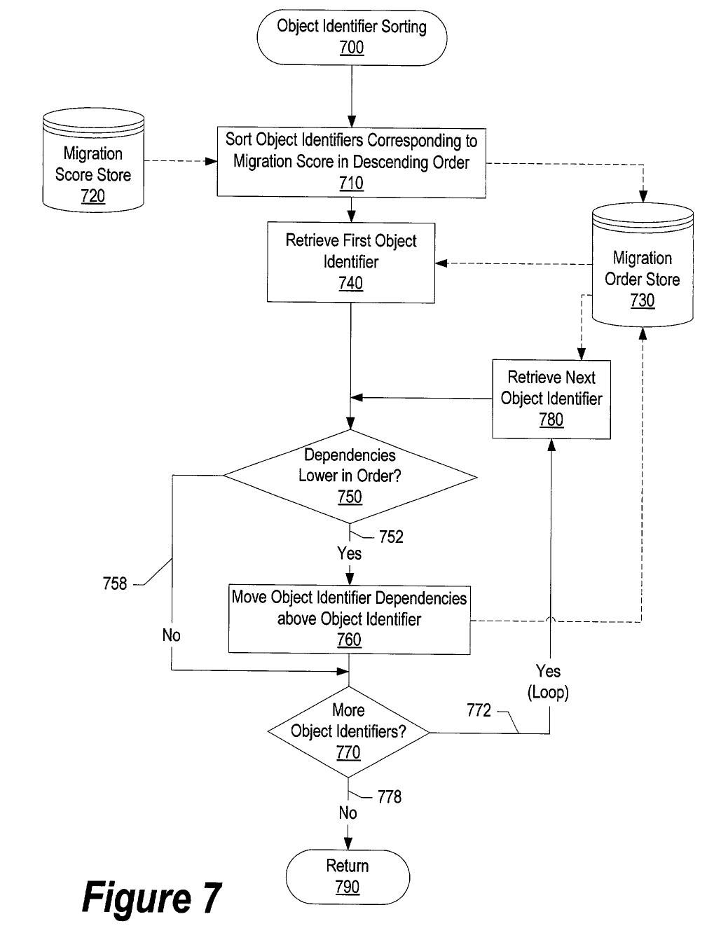

Compute engine 140 generates migration order 150 which includes a sorted list of object identifiers based upon corresponding migration scores and dependencies of each object identifier (see FIG. 7 for further details regarding object identifier migration order generation). Migration order 150 is imported into project planner 160 to generate a migration schedule (migration schedule 170). Project planner 160 may be a software program, such as Microsoft Project, capable of generating project plans. Information Systems (IS) staff input may be input into project planner 160, such as resource availability, to create a realistic migration schedule. Migration schedule 170 is sent to IS staff 180 for implementation.

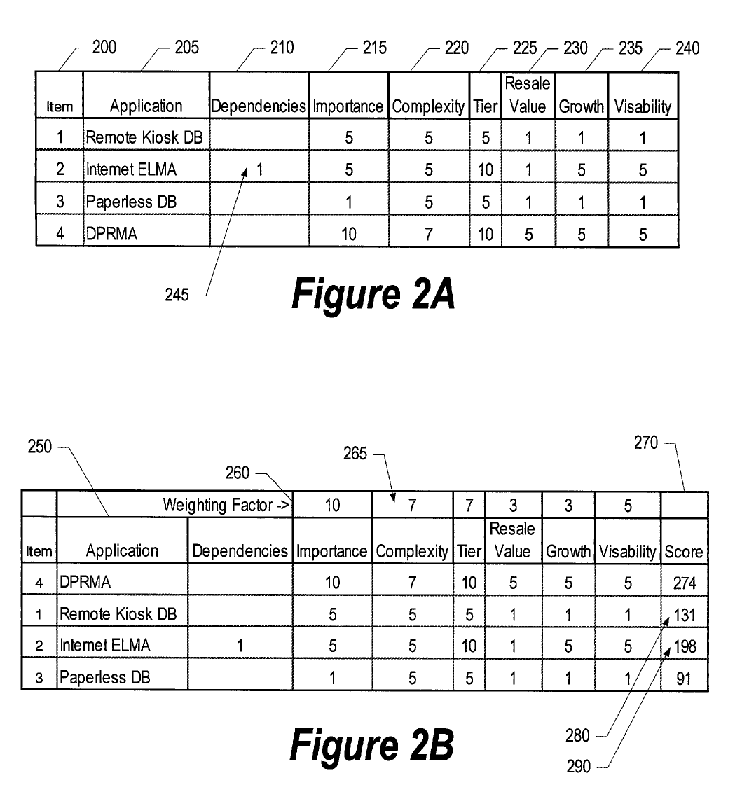

FIG. 2A is a spreadsheet example showing object identifier grades for various decision factors. Column 200 includes an item number corresponding to each object identifier for use in indicating object identifier dependencies (described below). Column 205 includes a list of object identifiers that correspond to selected objects for migration. The objects may include applications, databases, and data structures. Column 210 includes item numbers corresponding to object identifier dependencies. Meaning, if “object A” requires “object B” to migrate first, “object A” is dependent upon “object B”. For example, box 245 indicates that “Internet ELMA” depends upon item 1, or “Remote Kiosk DB”. Therefore, “Remote Kiosk DB” needs to migrate prior to “Internet ELMA”.

Columns 215 through 240 are decision factors in which the customer selects. Column 215 includes “Importance” object identifier grades for corresponding object identifiers. The “Importance” object identifier grade may be based on the business need of the corresponding object. For example, if an object is used to issue billing statements, the corresponding “Importance” object identifier grade may be high. On the other hand, if the object is used to store historical information, the corresponding “Importance” object identifier grade may be low.

Column 220 includes “Complexity” object identifier grades for corresponding object identifiers. Grading the complexity of the object may include analyzing the corresponding system's performance, the corresponding application's tier level, the number of supporting systems or servers, whether the corresponding systems are clustered, and the number of interfaces. In this example, column 225 includes “Object Tier” grades for corresponding object identifiers. The customer may consider it more desirable to accelerate the migration of objects associated with three-tier applications before those associated with two-tier applications.

Column 230 includes “Resale Value” object identifier grades for corresponding object identifiers. The resale value corresponds to the resale value of the platform in which the corresponding object is using to operate. For example, an application may be operating on a new server which is able to be re-sold for a high dollar amount. In this example, the “resale value” object identifier grade corresponding to the application is high.

Column 235 includes “Growth” object identifier grades for corresponding object identifiers. Objects may be graded according to how fast they are growing. For example, a customer may request to migrate objects from old systems to new systems that are growing exponentially before the growing objects exhaust the old system's resources, such as disk space, memory, or processing power.

Column 240 includes “Visibility” object identifier grades for corresponding object identifiers. Grading the object visibility may include analyzing the relative end use of the application, the number of users, and the importance of users. For example, if top management frequently uses an object for strategic projects, the corresponding “visibility” object identifier grade will be high.

FIG. 2B is a spreadsheet showing object identifiers sorted based upon migration scores and corresponding dependencies. Column 250 shows the migration order of object identifiers based upon their corresponding migration score and dependencies (described below). Row 260 includes decision factor weightings for corresponding decision factors. A decision factor weighting is a positive or negative number used to show how important each particular decision factor is compared to the other decision factors in determining the migration order of an object.

A positive decision factor weighting indicates that the decision factor contributes to early migration while a negative decision factor indicates that the decision factor contributes to late migration. A small number indicates that the decision factor is less important, and may serve as a “tie breaker” for two applications with very similar assessments. A large number indicates that the decision factor is more important and is critical in determining early object migration. For example, on a scale from one to ten, box 265 indicates that the “complexity” decision factor has a weighting of “7” which indicates that “complexity” is critical in determining the migration order of objects.

Column 270 shows migration scores for corresponding object identifiers (see FIG. 6 for further details regarding migration score calculations). The migration scores are sorted in descending order. However, box 280 (migration score=131) is above box 290 (migration score=198) because object identifier “Internet ELMA” is dependent upon object identifier “Remote Kiosk DB”. Therefore, “Remote Kiosk DB” is moved in front of “Internet ELMA” in migration order.

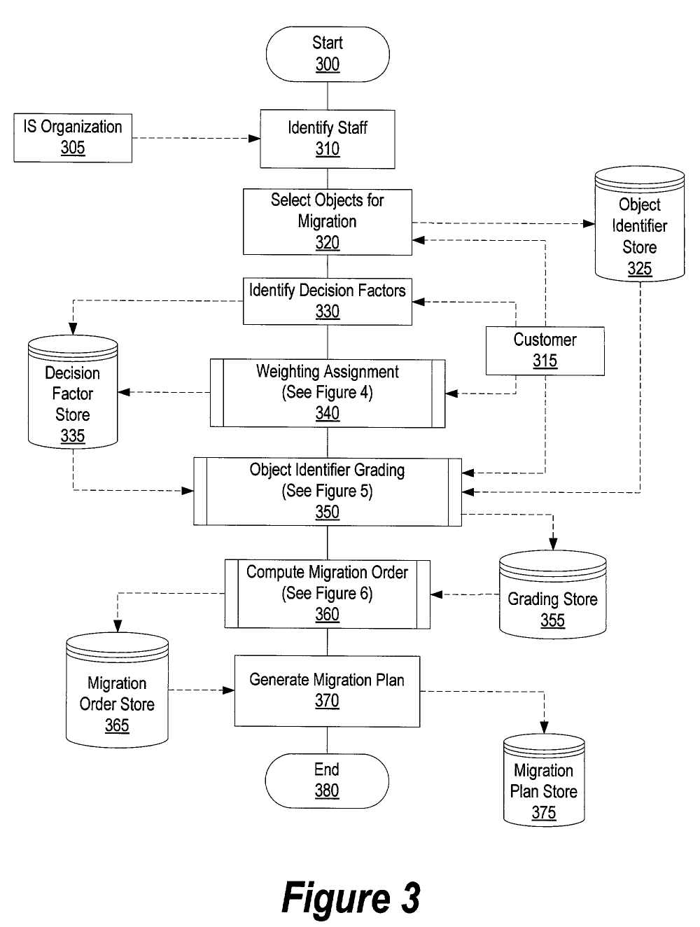

FIG. 3 is a high-level flowchart showing steps taken in generating a software migration plan. Processing commences at 300, whereupon staff is identified from IS organization 305 (step 310). The staff is responsible for overseeing and implementing the software migration plan. Customer 315 selects objects for migration and provides an object identifier (i.e. object name) for each object which is stored in object identifier store 325 (step 320). Object identifier store 325 may be stored on a non-volatile storage area, such as a computer hard drive. Objects may include applications, databases, data structures, and files. For example, if a server is being removed from a computer system, then each object (i.e. applications, databases, data structures, and files) on the server is selected for migration.

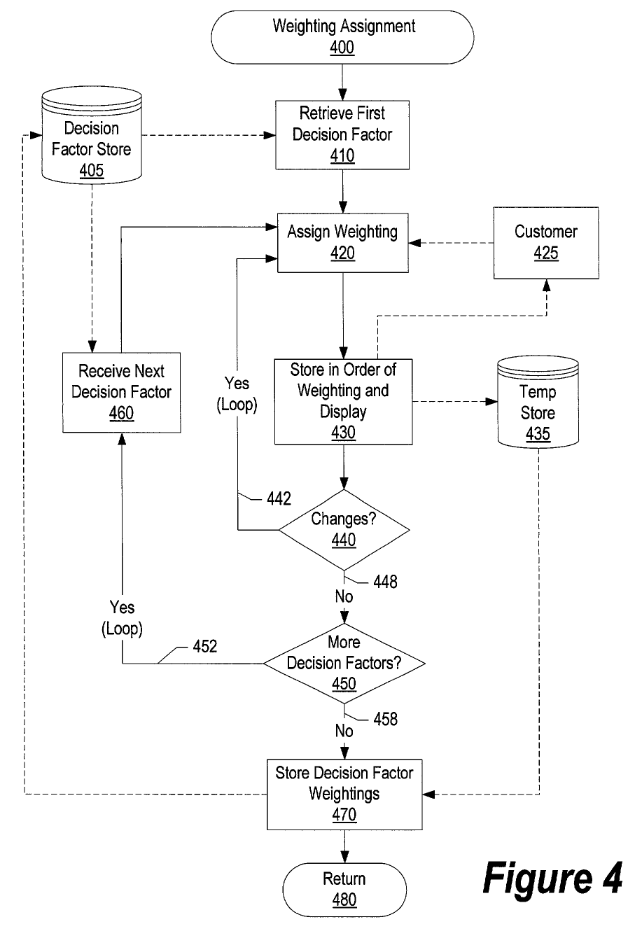

Customer 315 identifies decision factors which are stored in decision factor store 335 at step 330. Decision factors may include the importance of an object, the complexity of moving the object, and the number of tier in the object (see FIG. 2A for further details regarding decision factors). Decision factor store 335 may be stored on a non-volatile storage area, such as a computer hard drive. A decision factor weighting is assigned to each decision factor (pre-defined process block 340, see FIG. 4 for further details). For example, a weighting scale may be from one to ten wherein a ten corresponds to a decision factor with high importance and a one corresponds to a decision factor with low importance.

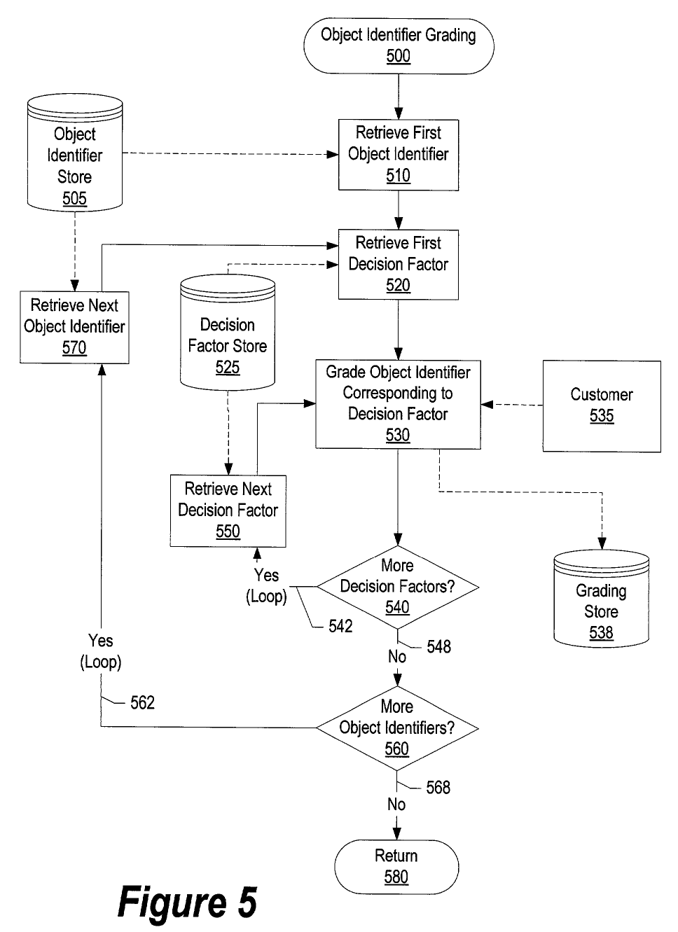

Customer 315 assigns an object identifier grade for each decision factor corresponding to each object identifier (pre-defined process block 350, see FIG. 5 for further details). The object identifier grades are stored in grading store 355. Grading store 355 may be stored on a non-volatile storage area, such as a computer hard drive. Processing computes a migration order using customer grading information located in grading store 355 and stores the migration order in migration order store 365. The migration order may be stored in spreadsheet format for easier importing into a project planning software for schedule generation. Migration order store 365 may be stored on a non-volatile storage area, such as a computer hard drive.

Processing generates a migration plan using the migration order in migration order store 365 and stores the migration plan in migration plan store 375. Migration plan store 375 may be stored on a non-volatile storage area, such as a computer hard drive. The migration schedule may be generated with project planning software, such as Microsoft Project. An Information System (IS) staff member may also provide information to the project planning software, such as available resources, to assist in generating a realistic migration plan. Processing ends at 380.

FIG. 4 is a flowchart assigning weightings to corresponding decision factors. Processing commences at 400, whereupon a first decision factor is retrieved from decision factor store 405 (step 410). Decision factor store 405 may be stored on a non-volatile storage area, such as a computer hard drive. Customer 425 reviews the decision factor and assigns a weighting at step 420. The decision factor is stored in temp store 435 in order of weighting and may be displayed at step 430. Customer 425 may review the recent decision factor weighting assignment relative to other decision factor weightings and make a determination as to whether to make changes to the recent decision factor weighting (decision 440). If the customer wants to make changes, decision 440 branches to “Yes” branch 442 which loops back to process the new weighting assignment. This looping continues until there are no more changes to make regarding the decision factor weighting, at which point decision 440 branches to “No” branch 448.

A determination is made as to whether there are more decision factors to assign weightings (decision 450). If there are more decision factors to assign weightings, decision 450 branches to “Yes” branch 452 which loops back to retrieve (step 460) and process the next decision factor. This looping continues until there are no more decision factors, at which point decision 450 branches to “No” branch 458. Final decision factor weightings are stored with their corresponding decision factors in decision factor store 405 (step 470). Processing ends at 480.

FIG. 5 is a flowchart showing a customer assigning object identifier grades to corresponding decision factors. Processing commences at 500, whereupon a first object identifier is retrieved from object identifier store 505 (step 510). The object identifier corresponds to an object which will be migrated. Object identifier store 505 may be stored on a non-volatile storage area, such as a computer hard drive. A first decision factor is retrieved from decision factor store 525 at step 520. Decision factor store 525 may be stored on a non-volatile storage area, such as a computer hard drive.

Customer 535 assigns an object identifier grade to the corresponding decision factor and the object identifier grade is stored in grading store 538 (step 530). Customer 535 may use a scale from one to ten with ten being the highest grade. For example, if the retrieved decision factor was “importance” and the corresponding object identifier was the most important relative to the other object identifiers, the customer may assign an object identifier grade of “ten”.

A determination is made as to whether there are more decision factors (decision 540). If there are more decision factors, decision 540 branches to “Yes” branch 542 which loops back to retrieve (step 550) and process the next decision factor. This looping continues until there are no more decision factors to process for the object identifier, at which point decision 540 branches to “No” branch 548.

A determination is made as to whether there are more object identifiers to process (decision 560). If there are more object identifiers to process, decision 560 branches to “Yes” branch 562 which loops back to retrieve (step 570) and process the next object identifier. This looping continues until there are no more object identifiers to process, at which point decision 560 branches to “No” branch 568. Processing returns at 580.

FIG. 6 is a flowchart showing steps taken in computing migration scores for use in generating a migration order. Processing commences at 600, whereupon the first object identifier is retrieved from object identifier store 610. Object identifier store 610 may be stored on a non-volatile storage area, such as a computer hard drive. A first decision factor and weighting are retrieved from decision factor store 620 at step 615. For example, an “Importance” decision factor with a weighting of “7” may be retrieved. Decision factor store 620 may be stored on a non-volatile storage area, such as a computer hard drive.

An object identifier grade corresponding to the object identifier and decision factor is retrieved from grading store 630 at step 625 (see FIG. 5 for further details regarding object identifier grading). Using the example described above, the customer may have assigned an object identifier grade of “8” for an object identifier that has high “importance”.

The object identifier grade is multiplied with the decision factor weighting and the result (decision factor score) is stored in multiply store 640. Using the example described above, multiplying a weighting of “7” and an object identifier grade of “8” results in a decision factor score of “56” which is stored in multiply store 640. Multiply store 640 may be stored on a non-volatile storage area, such as a computer hard drive.

A determination is made as to whether there are more decision factors (decision 645). If there are more decision factors, decision 645 branches to “Yes” branch 647 which loops back to select (step 650) and process the next decision factor and corresponding weighting. This looping continues until there are no more decision factors to process for the identified object identifier, at which point decision 645 branches to “No” branch 649.

The decision factor scores for the identified object identifier are added together at step 655. Using the example described above, the decision factor score of “56” is added to the rest of the decision factor scores. The summation of the decision factor scores for a particular object identifier results in a migration score that is stored in migration score store 660 (step 655). Migration score store 660 may be stored on a non-volatile storage area, such as a computer hard drive.

A determination is made as to whether there are more object identifiers to process (decision 665). If there are more object identifiers to process, decision 665 branches to “Yes” branch 667 which loops back to identify (step 670) and process the next object identifier. This looping continues until there are no more object identifiers to process, at which point decision 665 branches to “No” branch 669.

The object identifiers are sorted based upon their corresponding migration score and object identifier dependencies (pre-defined process block 675, see FIG. 7 for further details) . The sorted object identifiers are stored in migration order store 680. Migration order store 680 may be stored on a non-volatile storage area, such as a computer hard drive. Processing returns at 690.

FIG. 7 is a flowchart showing steps taken in generating a migration order based upon migration scores and object identifier dependencies. Processing commences at 700, whereupon object identifiers and corresponding migration scores are retrieved from migration score store 720 and sorted in descending order based upon their corresponding migration score and stored in migration order store 730 (step 710). Migration score store 720 may be stored on a non-volatile storage area, such as a computer hard drive. Migration order store 730 may be stored on a non-volatile storage area, such as a computer hard drive.

The first object identifier is retrieved at step 740. Since the object identifiers have been sorted in descending order based upon corresponding migration scores, the first object identifier has the highest migration score. A determination is made as to whether the first object identifier has dependencies which are lower in migration order. For example, an application corresponding to the first object identifier may be dependent upon a database to migrate first whose object identifier is lower in migration order.

If the object identifier does not have dependencies lower in order, decision 750 branches to “No” branch 758 bypassing migration order changes. If the object identifier has dependencies lower in order, decision 750 branches to “Yes” branch 752. The migration order of the object identifier dependency is moved in front of the object identifier in migration order store 730 (step 760). Using the example described above, the database object identifier is moved in front of the application object identifier regarding migration order.

A determination is made as to whether there are more object identifiers to analyze (decision 770). If there are more object identifiers to analyze, decision 770 branches to “Yes” branch 772 which loops back to retrieve (step 780) and process the next object identifier. This looping continues until there are no more object identifiers to process, at which point decision 770 branches to “No” branch 778. Processing returns at 790.

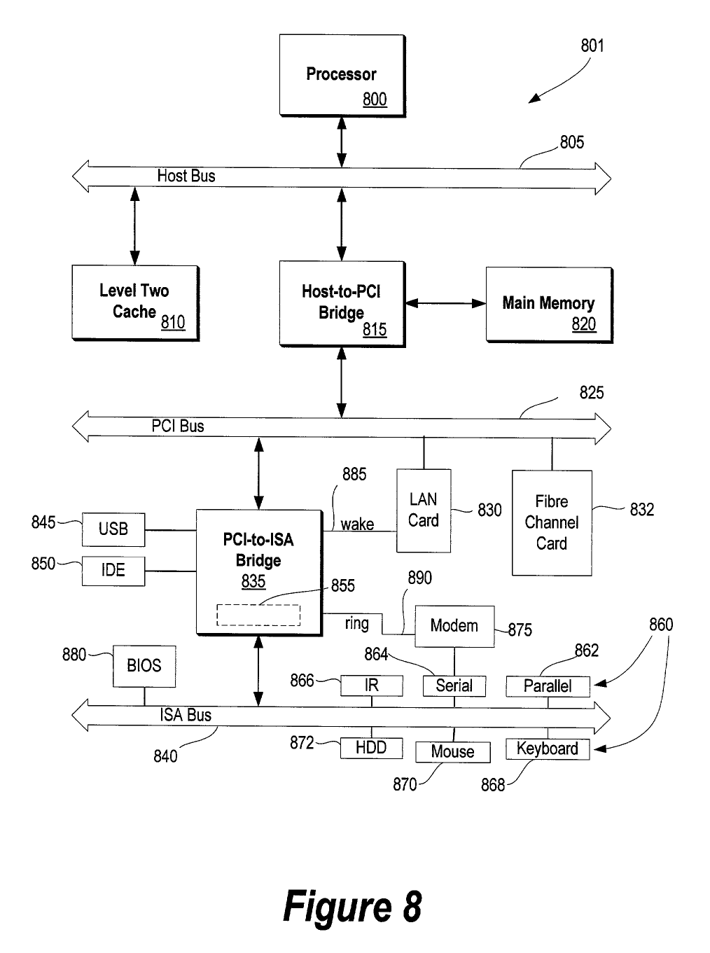

FIG. 8 illustrates information handling system 801 which is a simplified example of a computer system capable of performing the server and client operations described herein. Computer system 801 includes processor 800 which is coupled to host bus 805. A level two (L2) cache memory 810 is also coupled to the host bus 805. Host-to-PCI bridge 815 is coupled to main memory 820, includes cache memory and main memory control functions, and provides bus control to handle transfers among PCI bus 825, processor 800, L2 cache 810, main memory 820, and host bus 805. PCI bus 825 provides an interface for a variety of devices including, for example, LAN card 830. PCI-to-ISA bridge 835 provides bus control to handle transfers between PCI bus 825 and ISA bus 840, universal serial bus (USB) functionality 845, IDE device functionality 850, power management functionality 855, and can include other functional elements not shown, such as a real-time clock (RTC), DMA control, interrupt support, and system management bus support. Peripheral devices and input/output (I/O) devices can be attached to various interfaces 860 (e.g., parallel interface 862, serial interface 864, infrared (IR) interface 866, keyboard interface 868, mouse interface 870, and fixed disk (HDD) 872) coupled to ISA bus 840. Alternatively, many I/O devices can be accommodated by a super I/O controller (not shown) attached to ISA bus 840.

BIOS 880 is coupled to ISA bus 840, and incorporates the necessary processor executable code for a variety of low-level system functions and system boot functions. BIOS 880 can be stored in any computer readable medium, including magnetic storage media, optical storage media, flash memory, random access memory, read only memory, and communications media conveying signals encoding the instructions (e.g., signals from a network). In order to attach computer system 801 to another computer system to copy objects over a network, LAN card 830 is coupled to PCI bus 825 and to PCI-to-ISA bridge 835. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for managing object migration, said method comprising:
selecting a plurality of object identifiers, the object identifiers corresponding to a plurality of objects;
retrieving a migration algorithm;
calculating a migration score for each of the object identifiers using the migration algorithm;
sorting the object identifiers based upon the migration score, the sorting resulting in a migration order; and
generating a migration plan based upon the migration order.

2. The method as described in claim 1 wherein the sorting further comprises:
determining whether a first object identifier depends upon a second object identifier;
comparing the migration score corresponding to the first object identifier to the migration score corresponding to the second object identifier based upon the determination; and
moving the second object identifier before the first object identifier in the migration order based upon the comparing.

3. The method as described in claim 1 wherein the calculating further comprises:
identifying one or more decision factors;
assigning a decision factor weighting to each decision factor;
registering an object identifier grade for each decision factor corresponding to one of the object identifiers;
multiplying one or more decision factor weightings with one or more corresponding object identifier grades, the multiplying resulting in one or more decision factor scores; and
adding one or more decision factor scores together corresponding to the object identifier, the addition creating the migration score.

4. The method as described in claim 3 wherein the decision factors are selected from the group consisting of an importance, a complexity, a tier, a resale value, a growth, and a visibility.

5. The method as described in claim 1 wherein the sorting further comprising:
determining whether a first object identifier depends upon a second object identifier;
comparing the migration score corresponding to the first object identifier to the migration score corresponding to the second object identifier based upon the determination; and
moving the second object identifier after the first object identifier in the migration order based upon the comparing.

6. The method as described in claim 1 wherein the objects are selected from the group consisting of an application, a database, a data structure, and a file.

7. The method as described in claim 1 wherein the generating further comprises:
receiving a resource availability, wherein the resource availability corresponds to available resources to implement the migration plan.

8. An information handling system comprising:
one or more processors;
a memory accessible by the processors;
one or more nonvolatile storage devices accessible by the processors;
an object migration management tool to manage object migrations, the object migration management tool including:
means for selecting a plurality of object identifiers, the object identifiers corresponding to a plurality of objects;
means for retrieving a migration algorithm;
means for calculating a migration score for each of the object identifiers using the migration algorithm;
means for sorting the object identifiers based upon the migration score, the sorting resulting in a migration order; and
means for generating a migration plan based upon the migration order.

9. The information handling system as described in claim 8 wherein the means for sorting further comprises:
means for determining whether a first object identifier depends upon a second object identifier;
means for comparing the migration score corresponding to the first object identifier to the migration score corresponding to the second object identifier based upon the determination; and
moving the second object identifier before the first object identifier in the migration order based upon the comparing.

10. The information handling system as described in claim 8 wherein the means for calculating further comprises:
means for identifying one or more decision factors;
means for assigning a decision factor weighting to each decision factor;
means for registering an object identifier grade for each decision factor corresponding to one of the object identifiers;
means for multiplying one or more decision factor weightings with one or more corresponding object identifier grades, the multiplying resulting in one or more decision factor scores; and
means for adding one or more decision factor scores together corresponding to the object identifier, the addition creating the migration score.

11. The information handling system as described in claim 10 wherein the decision factors are selected from the group consisting of an importance, a complexity, a tier, a resale value, a growth, and a visibility.

12. The information handling system as described in claim 8 wherein the objects are selected from the group consisting of an application, a database, a data structure, and a file.

13. The information handling system as described in claim 8 wherein the means for generating further comprises:
means for receiving a resource availability, wherein the resource availability corresponds to available resources to implement the migration plan.

14. A computer program product stored in a computer operable media for managing object migration, said computer program product comprising:
means for selecting a plurality of object identifiers, the object identifiers corresponding to a plurality of objects;
means for retrieving a migration algorithm;
means for calculating a migration score for each of the object identifiers using the migration algorithm;
means for sorting the object identifiers based upon the migration score, the sorting resulting in a migration order; and
means for generating a migration plan based upon the migration order.

15. The computer program product as described in claim 14 wherein the means for sorting further comprises:
means for determining whether a first object identifier depends upon a second object identifier;
means for comparing the migration score corresponding to the first object identifier to the migration score corresponding to the second object identifier based upon the determination; and
means for moving the second object identifier before the first object identifier in the migration order based upon the comparing.

16. The computer program product as described in claim 14 wherein the means for calculating further comprises:
means for identifying one or more decision factors;
means for assigning a decision factor weighting to each decision factor;
means for registering an object identifier grade for each decision factor corresponding to one of the object identifiers;
means for multiplying one or more decision factor weightings with one or more corresponding object identifier grades, the multiplying resulting in one or more decision factor scores; and
means for adding one or more decision factor scores together corresponding to the object identifier, the addition creating the migration score.

17. The computer program product as described in claim 16 wherein the decision factors are selected from the group consisting of an importance, a complexity, a tier, a resale value, a growth, and a visibility.

18. The computer program product as described in claim 14 wherein the means for sorting further comprising:
means for determining whether a first object identifier depends upon a second object identifier;
means for comparing the migration score corresponding to the first object identifier to the migration score corresponding to the second object identifier based upon the determination; and
means for moving the second object identifier after the first object identifier in the migration order based upon the comparing.

19. The computer program product as described in claim 14 wherein the objects are selected from the group consisting of an application, a database, a data structure, and a file.

20. The computer program product as described in claim 14 wherein the means for generating further comprises:
means for receiving a resource availability, wherein the resource availability corresponds to available resources to implement the migration plan.
